(19) United States
(12) Patent Application Publication
(10) Pub. No.: US 2026/0027952 A1
(43) Pub. Date: Jan. 29, 2026

(54) VEHICLE SEAT

(71) Applicants: NHK SPRING CO., LTD., Yokohama-shi (JP); SUBARU CORPORATION, Tokyo (JP)

(72) Inventors: Jun TAKEDA, Yokohama-shi (JP); Mitsuaki ODA, Yokohama-shi (JP); Yosuke ISHIYAMA, Tokyo (JP); Masato FUKUSHIMA, Tokyo (JP)

(21) Appl. No.: 19/276,643

(22) Filed: Jul. 22, 2025

(30) Foreign Application Priority Data
Jul. 24, 2024 (JP) 2024-118754

(51) Int. Cl. B60N 2/02; B60N 2/62; B60N 2/90

(52) U.S. Cl. CPC B60N 2/0284; B60N 2/62; B60N 2/99

(57) ABSTRACT

A vehicle seat includes: a pair of left and right side frames that structure portions of a frame of a seat cushion that supports, from a seat lower side, buttocks and femoral regions of a seated vehicle occupant, and that are disposed with an interval therebetween in a seat left-right direction; and a spanning member spanning in the seat left-right direction between the pair of left and right side frames, and supporting the femoral regions of the seated vehicle occupant from a lower side, wherein regions, which are at rear sides of seat transverse direction outer sides, of the spanning member are projecting portions that project toward a seat upper side with respect to the side frames.

### CROSS-REFERENCE TO RELATED APPLICATION

This application is based on and claims priority under 35 USC 119 from Japanese Patent Application No. 2024-118754 filed on Jul. 24, 2024, the disclosure of which is incorporated by reference herein.

### BACKGROUND

### Technical Field

The present disclosure relates to a vehicle seat.

### Related Art

Japanese Patent Application Laid-Open (JP-A) No. 2023-131625 discloses a vehicle seat equipped with a function that makes it possible to vary the length of a cushion such that a large load can be received. The vehicle seat disclosed in that publication has a front panel disposed at the front end side of a seat cushion, a sliding device that has a sliding member and can displace a movable portion in the seat front-rear direction, and a bracket connected to the front panel so as to be displaceable in the seat front-rear direction and displaced integrally with the sliding member. A large load that is inputted to the movable portion can be received by the load that is applied to the movable portion being transmitted to the front panel via the bracket.

The structure disclosed in JP-A No. 2023-131625 is a structure that is effective from the standpoint that it makes it possible to receive large loads inputted to the movable portion. However, there is room for improvement from the standpoint of reducing the load inputted to a spanning member such as a front panel at times when a vehicle occupant enters into or exits from the vehicle.

### SUMMARY

The present disclosure provides a vehicle seat that can reduce the load inputted to a spanning member at times when a vehicle occupant enters into or exits from a vehicle.

A vehicle seat of a first aspect includes: a pair of left and right side frames that structure portions of a frame of a seat cushion that supports, from a seat lower side, buttocks and femoral regions of a seated vehicle occupant, and that are disposed with an interval therebetween in a seat left-right direction; and a spanning member spanning in the seat left-right direction between the pair of left and right side frames, and supporting the femoral regions of the seated vehicle occupant from a lower side, wherein regions, which are at rear sides of seat transverse direction outer sides, of the spanning member are projecting portions that project toward a seat upper side with respect to the side frames.

In the vehicle seat of the first aspect, the rear side regions of the spanning member are the projecting portions that project toward the seat upper side with respect to the side frames. Therefore, the body of the vehicle occupant at the time when the vehicle occupant enters into or exits from the vehicle can be made to approach the projecting portion sides, as compared with a structure that does not have the projecting portions. As a result, the load from a vehicle occupant at the time when the vehicle occupant enters into or exits from the vehicle can be received by the projecting portions. Due thereto, the load inputted to the region of the spanning member, which region is further toward the front side than the projecting portions, from the vehicle occupant at the time when the vehicle occupant enters into or exits from the vehicle can be reduced.

In a vehicle seat of a second aspect, in the vehicle seat of the first aspect, owing to regions, which are at a seat rear side, of the spanning member being supported portions that are supported at the pair of left and right side frames so as to be rotatable with the seat left-right direction being an axial direction, the spanning member is displaced with respect to the pair of left and right side frames, and a position of a front end portion of the seat cushion in a seat vertical direction is adjusted, and the vehicle seat further includes a movable portion that is supported by the spanning member and by which a length of the seat cushion in a seat front-rear direction is adjusted owing to the movable portion being displaced in a seat front-rear direction with respect to the spanning member, and regions of the spanning member, which regions are at a seat upper side with respect to the supported portions, are the projecting portions.

In the vehicle seat of the second aspect, owing to the spanning member being displaced with respect to the pair of left and right side frames, the position of the front end portion of the seat cushion in the seat vertical direction is adjusted. Further, owing to the movable portion being displaced in the seat front-rear direction with respect to the spanning member, the length of the seat cushion in the seat front-rear direction is adjusted. Here, in the vehicle seat of the second aspect, the regions of the spanning member, which regions are at the seat upper side with respect to the supported portions, are the projecting portions that project out toward the seat upper side with respect to the side frames. Therefore, the body of the vehicle occupant at the time when the vehicle occupant enters into or exits from the vehicle can be made to approach the projecting portion sides, as compared with a structure that does not have the projecting portions. As a result, the load from a vehicle occupant at the time when the vehicle occupant enters into or exits from the vehicle can be received by the projecting portions. Due thereto, the load inputted to the movable portion from the vehicle occupant at the time when the vehicle occupant enters into or exits from the vehicle can be reduced.

In a vehicle seat of a third aspect, in the vehicle seat of the second aspect, in a seat side view, end portions, which are at a seat rear side and a seat upper side, of the projecting portions are first load input portions, and an end portion, which is at a seat front side and a seat upper side, of the movable portion is a second load input portion, and, in a case in which a line that passes through the first load input portion and extends in a direction in which the movable portion is displaced with respect to the spanning member is a contact line, the second load input portion is positioned further toward a seat lower side than the contact line.

In the vehicle seat of the third aspect, the second load input portion is positioned further toward the seat lower side than the contact line. In this structure, the frequency of the vehicle occupant pushing the second load input portion at the time of entering into or exiting from the vehicle can be reduced, as compared with a structure in which the second load input portion is positioned further toward the upper side than the contact line. As a result, the load inputted to the movable portion from the vehicle occupant at the time when the vehicle occupant enters into and exits from the vehicle can be reduced even more.

In a vehicle seat of a fourth aspect, in the vehicle seat any one of the first aspect through the third aspect, in a seat side view of a state in which an AM50 dummy serving as the seated vehicle occupant is seated on the seat cushion, a line connecting a hip point and a knee joint center of the dummy is a first line, and a line that is parallel to the first line and passes through a projection direction distal end of the projecting portion is a second line, and a region of the spanning member, which region is further toward a front side than the projecting portions, is positioned further toward a lower side than the second line.

In the vehicle seat of the fourth aspect, the load from the vehicle occupant at the time when the vehicle occupant enters into or exits from the vehicle can be received more reliably by the projecting portions, as compared with a structure in which the region of the spanning member that is further toward the front side than the projecting portions is not positioned further toward the lower side than the second line. Due thereto, the load that is inputted to the region, which is further toward the front side than the projecting portions, of the spanning member from the vehicle occupant at the time when the vehicle occupant enters into or exits from the vehicle can be reduced.

In a vehicle seat of a fifth aspect, in the vehicle seat of the fourth aspect, in a seat side view of the state in which the dummy is seated on the seat cushion, a shape and dimensions of the spanning member are configured such that, in a case in which the first line is rotated toward the spanning member side around the hip point, the first line contacts the projecting portions first.

In the vehicle seat of the fifth aspect, the load from the vehicle occupant at the time when the vehicle occupant enters into or exits from the vehicle can be received more reliably by the projecting portions, as compared with a structure in which the shape and dimensions of the spanning member are set to be a shape and dimensions that are different than those described above. Due thereto, the load that is inputted to the region, which is further toward the front side than the projecting portions, of the spanning member from the vehicle occupant at the time when the vehicle occupant enters into or exits from the vehicle can be reduced.

In a vehicle seat of a sixth aspect, in the vehicle seat of the fourth aspect or the fifth aspect, in a seat side view of the state in which the dummy is seated on the seat cushion, the projecting portions are positioned further toward a rear side than a center, on the first line, between the hip point and the knee joint center.

In the vehicle seat of the sixth aspect, the load from the vehicle occupant at the time when the vehicle occupant enters into or exits from the vehicle can be received more reliably by the projecting portions, as compared with a structure in which the position of the projecting portions is set to be a position that is different than that described above. Due thereto, the load that is inputted to the region, which is further toward the front side than the projecting portions, of the spanning member from the vehicle occupant at the time when the vehicle occupant enters into or exits from the vehicle can be reduced.

In a vehicle seat of a seventh aspect, in the vehicle seat of any one of the first aspect through the sixth aspect, in a state in which an AM50 dummy serving as the seated vehicle occupant is seated on the seat cushion, the projecting portions are positioned at seat transverse direction outer sides with respect to the dummy.

In the vehicle seat of the seventh aspect, due to the projecting portions being positioned at the seat transverse direction outer sides with respect to the dummy, the foreign object sensation of the projecting portions when the vehicle occupant is seated can be reduced.

In a vehicle seat of an eighth aspect, in the vehicle seat of the second aspect, or any one of the third aspect through the seventh aspect that has the structure of the second aspect, projection direction distal ends of the projecting portions are positioned at a rear side with respect to a center of rotation of the supported portions.

In the vehicle seat of the eighth aspect, the load from the vehicle occupant at the time when the vehicle occupant enters into or exits from the vehicle can be received more reliably by the projecting portions, as compared with a structure in which the projecting direction distal ends of the projecting portions are positioned at the front side with respect to the center of rotation of the supported portions. Due thereto, the load that is inputted to the movable portion and to the region, which is further toward the front side than the projecting portions, of the spanning member from the vehicle occupant at the time when the vehicle occupant enters into or exits from the vehicle can be reduced.

The vehicle seat relating to the present disclosure has the effect of being able to reduce load that is inputted to a spanning member at times when a vehicle occupant enters into or exits from a vehicle.

### BRIEF DESCRIPTION OF THE DRAWINGS

An exemplary embodiment of the present disclosure will be described in detail based on the following figures, wherein:

FIG. 1 is a perspective view illustrating a seat cushion of a vehicle seat of a present embodiment;

FIG. 2 is a perspective view illustrating the front portion of the seat cushion in a state in which a cushion pad has been removed; and

FIG. 3 is a side view in which main portions of the seat cushion are viewed from a lateral side.

### DETAILED DESCRIPTION

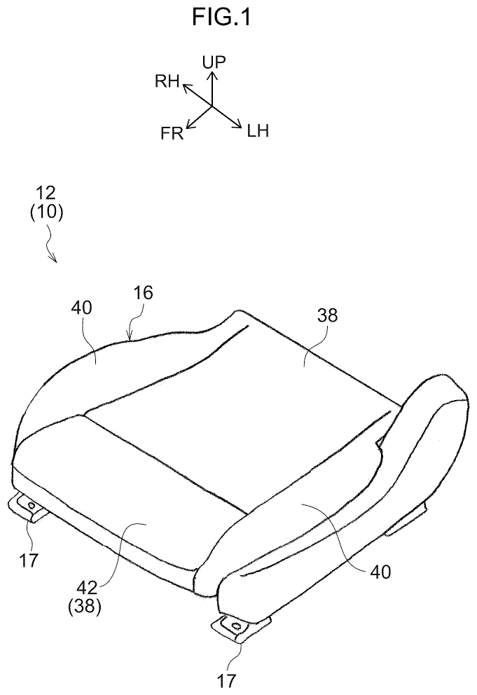

A vehicle seat 10 relating to an embodiment of the present disclosure is described by using FIG. 1 through FIG. 3. Note that arrow FR in the drawings indicates the seat front side, arrow UP indicates the seat upper side, arrow LH indicates the seat transverse direction left side, and arrow RH indicates the seat transverse direction right side. Further, when front-rear, vertical (upper-lower) and left-right directions are used in the following description, unless otherwise specified, they refer to the front-rear of the seat front-rear direction, the vertical of the seat vertical direction, and the left-right of the left and right in the seat transverse direction.

As illustrated in FIG. 1, the vehicle seat 10 of the present embodiment has a seat cushion 12 that supports the buttocks of a seated vehicle occupant from the lower side. As illustrated in FIG. 1 through FIG. 3, the seat cushion 12 has a cushion frame 14 structuring the frame of the seat cushion 12, and a cushion pad 16 mounted to the cushion frame 14. The vehicle seat 10 of the present embodiment has a tilting mechanism 18 that adjusts the position of the front end portion of the seat cushion 12 in the seat vertical direction, and a length adjusting mechanism 20 that adjusts the length of the seat cushion 12 in the front-rear direction.

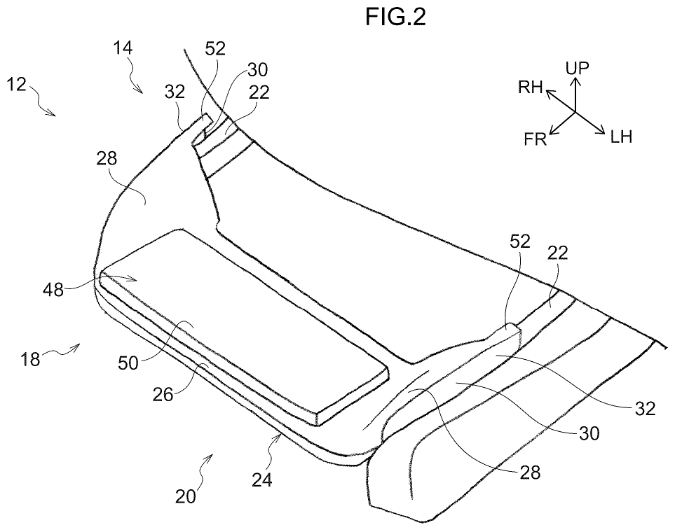

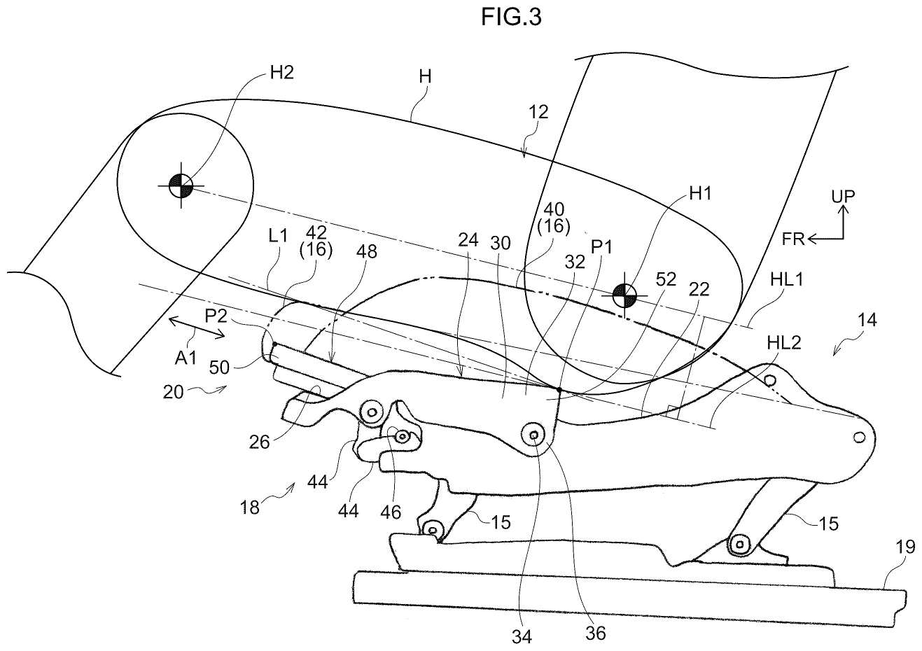

As illustrated in FIG. 2 and FIG. 3, the cushion frame 14 is structured to include a pair of left and right side frames 22 that are disposed with an interval therebetween in the left-right direction and extend in the front-rear direction, and a front panel 24 serving as a spanning member that spans between the pair of left and right side frames 22 in the left-right direction at the front end side of the pair of left and right side frames 22. Note that the cushion frame 14 is supported by seat sliding rails 19 via lifter links 15.

The front panel 24 has a central extending portion 26 that extends in the left-right direction and the front-rear direction. The central extending portion 26 is inclined toward the upper side while heading toward the front side. Further, the front panel 24 has a pair of left and right outer side first extending portions 28 that respectively extend from the both end portions in the left-right direction of the central extending portion 26 toward the sides opposite the central extending portion 26. The pair of left and right outer side first extending portions 28 are inclined toward the upper side while heading toward the sides opposite the central extending portion 26. Moreover, the front panel 24 has a pair of left and right outer side second extending portions 30 that respectively extend toward the lower side from the end portions, which are at the sides opposite the central extending portion 26, of the left and right pair of outer side first extending portions 28. Here, the rear side regions of the pair of left and right outer side first extending portions 28 and the rear side regions of the pair of left and right outer side second extending portions 30 are jutting portions 32 that jut out toward the rear side with respect to the rear end of the central extending portion 26. As illustrated in FIG. 3, the pair of left and right outer side second extending portions 30 are respectively disposed at the seat transverse direction outer sides with respect to the pair of left and right side frames 22. Further, the rear end portions of the pair of left and right outer side second extending portions 30 are rotatably supported, with the left-right direction being the axial direction, via a shaft member 34 at the pair of left and right side frames 22. Note that the regions, with which the shaft member 34 is engaged, of the rear end portions of the pair of left and right outer side second extending portions 30 are called supported portions 36.

As illustrated in FIG. 1 through FIG. 3, the cushion pad 16 is mounted to the cushion frame 14 from the upper side. Note that the seated vehicle occupant side of the cushion pad 16 is covered by trim. As illustrated in FIG. 1, the cushion pad 16 has a main portion 38 structuring the seat transverse direction central portion of the cushion pad 16, and a pair of left and right side support portions 40 structuring the seat transverse direction both side portions of the cushion pad 16. The pair of left and right side support portions 40 project-out toward the upper side with respect to the main portion 38. The front end side portion of the main portion 38 is a movable cushion portion 42 that can be displaced in the front-rear direction and the vertical direction with respect to the portion that is further toward the rear side than the front end side portion of the main portion 38.

As illustrated in FIG. 3, the tilting mechanism 18 is structured to include the above-described front panel 24, and plural left and right pairs of links 44. The plural links 44 at the left side connect the front-side region of the outer side first extending portion 28 at the left side of the front panel 24 and the side frame 22 that is at the left side. Further, although not illustrated, the plural links 44 at the right side connect the front-side region of the outer side first extending portion 28 at the right side of the front panel 24 and the side frame 22 that is at the right side. A given one link 44 among the plural links 44 at the left side and a given one link 44 among the plural links 44 at the right side are connected in the left-right direction via a tilt linking pipe 46. The movement of the plural links 44 at the left side and the movement of the plural links 44 at the right side is thereby synchronized. Note that the given one link 44 among the plural links 44 at the left side and the tilt linking pipe 46 are joined by welding. Further, the given one link 44 among the plural links 44 at the right side and the tilt linking pipe 46 are joined by welding. The front panel 24 can tilt in the vertical direction with the shaft member 34 being the center of rotation, due to the plural left and right pairs of links 44 being displaced electrically or manually.

As illustrated in FIG. 2 and FIG. 3, the length adjusting mechanism 20 has a length adjusting mechanism main body portion 48 fixed to the upper surface of the central extending portion 26 of the front panel 24. This length adjusting mechanism main body portion 48 is structured to include a movable portion 50 that displaces the movable cushion portion 42 in the front-rear direction by being displaced in the front-rear direction with respect to the front panel 24.

Here, as illustrated in FIG. 3, the regions, which are at the upper sides with respect to the supported portions 36, of the jutting portions 32 of the front panel 24 are projecting portions 52 that project out toward the upper side with respect to the side frames 22. Here, in a seat side view, the rear side and upper side end portions of the projecting portions 52 are called first load input portions P1. The first load input portions P1, which are the projection direction distal ends of the projecting portions 52, are positioned at the rear side with respect to the center of rotation of the supported portions 36. Further, the front side and upper side end portion of the movable portion 50 is called a second load input portion P2. Moreover, the line, which passes through the first load input portion P1 and extends in the direction (the direction of arrow A1) in which the movable portion 50 is displaced with respect to the front panel 24, is called contact line L1. In the present embodiment, the position of the second load input portion P2 is set further toward the lower side than the contact line L1.

Here, in a seat side view of a state in which a dummy H, which is an AM50 dummy (a dummy of a 50 percentile U.S. adult male) and serves as the seated vehicle occupant, is seated on the seat cushion 12, the line that connects hip point H1 and knee joint center H2 of the dummy H is first line HL1, and the line that is parallel to the first line HL1 and passes through the projection direction distal end of the projecting portion 52 (the first load input portion P1) is second line HL2. Further, in the present embodiment, the region, which is further toward the front side than the projecting portions 52, of the front panel 24 is positioned further toward the lower side than the second line HL2. Note that the hip point H1 is a reference point in terms of designing and measuring the seat, and a hip point position is determined for each dummy size. Further, the hip point coordinates at the time when the dummy H is seated in the seat are the hip point H1. The hip point H1 means the center of rotation that connects the torso region and the femoral region of the dummy H.

The shape and the dimensions of the front panel 24 are set such that, in a seat side view of a state in which the dummy H is seated on the seat cushion 12, if the first line HL1 is rotated around the hip point H1 toward the front panel 24 side, the first line HL1 contacts the projecting portions 52 first.

In a seat side view of the state in which the dummy H is seated on the seat cushion 12, the projecting portions 52 are positioned further toward the rear side than the center of the first line HL1 between the hip point H1 and the knee joint center H2.

Further, in the state in which the dummy H is seated on the seat cushion 12, the projecting portions 52 are positioned further toward the seat transverse direction outer sides than the dummy H.

### Operation and Effects of Present Embodiment

Operation and effects of the present embodiment are described next.

As illustrated in FIG. 1 through FIG. 3, at the vehicle seat 10 of the present embodiment, the position of the front end portion (the movable cushion portion 42) of the seat cushion 12 in the vertical direction is adjusted due to the front panel 24 tilting in the vertical direction with the shaft member 34 being the center of rotation.

Further, the movable cushion portion 42 is displaced in the front-rear direction due to the movable portion 50 of the length adjusting mechanism main body portion 48 being displaced in the front-rear direction with respect to the front panel 24. The length of the seat cushion 12 in the front-rear direction is thereby adjusted.

Here, in the vehicle seat 10 of the present embodiment, the regions of the jutting portions 32 of the front panel 24, which regions are at the upper side with respect to the supported portions 36, are the projecting portions 52 that project out toward the upper side with respect to the side frames 22. Therefore, the body of the vehicle occupant at the time when the vehicle occupant enters into or exits from the vehicle can be made to approach the projecting portions 52 side, as compared with a structure that does not have the projecting portions 52. As a result, the load received from a vehicle occupant at the time when the vehicle occupant enters into or exits from the vehicle can be received by the projecting portions 52. Due thereto, the load inputted to the movable portion 50 from the vehicle occupant at the time when the vehicle occupant enters into or exits from the vehicle can be reduced.

Further, in the present embodiment, the position of the second load input portion P2 is set to be further toward the lower side than the contact line L1. In this structure, the frequency of the vehicle occupant pushing the second load input portion P2 at the time of entering into or exiting from the vehicle can be reduced, as compared with a structure in which the second load input portion P2 is positioned further toward the upper side than the contact line L1. As a result, the load inputted to the movable portion 50 from the vehicle occupant at the time when the vehicle occupant enters into and exits from the vehicle can be reduced even more.

Further, in the present embodiment, the region of the front panel 24, which region is further toward the front side than the projecting portions 52, is positioned further toward the lower side than the second line HL2. In this structure, the load from the vehicle occupant at the time when the vehicle occupant enters into or exits from the vehicle can be received more reliably by the projecting portions 52, as compared with a structure in which the region of the front panel 24 that is further toward the front side than the projecting portions 52 is not positioned further toward the lower side than the second line HL2. Due thereto, the load that is inputted to the region (the movable portion 50) of the front panel 24, which region is further toward the front side than the projecting portions 52, from the vehicle occupant at the time when the vehicle occupant enters into or exits from the vehicle can be reduced.

In the present embodiment, the shape and the dimensions of the front panel 24 are set such that, in a seat side view of a state in which the dummy H is seated on the seat cushion 12, if the first line HL1 is rotated toward the front panel 24 side around the hip point H1, the first line HL1 contacts the projecting portions 52 first. In this structure, the load from the vehicle occupant at the time when the vehicle occupant enters into or exits from the vehicle can be received more reliably by the projecting portions 52, as compared with a structure in which the shape and dimensions of the front panel 24 are set to be a shape and dimensions that are different than those described above. Due thereto, the load that is inputted to the region (the movable portion 50) of the front panel 24 that is further toward the front side than the projecting portions 52 from the vehicle occupant at the time when the vehicle occupant enters into or exits from the vehicle can be reduced.

Further, in the present embodiment, in a seat side view of a state in which the dummy H is seated on the seat cushion 12, the projecting portions 52 are positioned further toward the rear side than the center that is between the hip point H1 and the knee joint center H2 on the first line HL1. In this structure, load from the vehicle occupant at the time when the vehicle occupant enters into or exits from the vehicle can be received more reliably by the projecting portions 52, as compared with a structure in which the position of the projecting portions 52 is set to be a position that is different than that described above. Due thereto, the load that is inputted to the region (the movable portion 50) of the front panel 24 that is further toward the front side than the projecting portions 52 from the vehicle occupant at the time when the vehicle occupant enters into or exits from the vehicle can be reduced.

In the present embodiment, in the state in which the dummy H is seated on the seat cushion 12, the projecting portions 52 are positioned at the seat transverse direction outer sides with respect to the dummy H. In this structure, the foreign object sensation of the projecting portions 52 when the vehicle occupant is seated can be reduced.

In the present embodiment, the first load input portions P1, which are the projection direction distal ends of the projecting portions 52, are positioned at the rear side with respect to the center of rotation of the supported portions 36. In this structure, the load from the vehicle occupant at the time when the vehicle occupant enters into or exits from the vehicle can be received more reliably by the projecting portions 52, as compared with a structure in which the projection direction distal ends of the projecting portions 52 are positioned at the front side with respect to the center of rotation of the supported portions 36. Due thereto, the load that is inputted to the region (the movable portion 50) of the front panel 24 that is further toward the front side than the projecting portions 52 from the vehicle occupant at the time when the vehicle occupant enters into or exits from the vehicle can be reduced.

Note that, although the present embodiment describes an example in which the position of the second load input portion P2 is set further toward the lower side than the contact line L1, the present disclosure is not limited to this. It suffices to determine whether or not the position of the second load input portion P2 is to be set further toward the lower side than the contact line L1 in consideration of the shape of the door opening portion of the vehicle, or the posture at the time when the vehicle occupant enters into and exits from the vehicle, or the like.

Although the present embodiment describes an example in which the front panel 24 is set as described above by using the dummy H, the present disclosure is not limited to this. It suffices to determine whether or not the front panel 24 is to be set as described above in consideration of the tolerance of the load inputted to the front panel 24, or the like.

The present embodiment describes an example in which the first load input portions P1, which are the projection direction distal ends of the projecting portions 52, are positioned at the rear side with respect to the center of rotation of the supported portions 36. However, the present disclosure is not limited to this. For example, a structure can be used in which the projection direction distal ends of the projecting portions 52 are positioned at the front side with respect to the center of rotation of the supported portions 36.

Although the present embodiment describes the vehicle seat 10 that is equipped with the tilting mechanism 18 and the length adjusting mechanism 20, the present disclosure is not limited to this. For example, the structure of the present disclosure can be applied to a vehicle seat that is not equipped with the tilting mechanism 18 and the length adjusting mechanism 20.

Although the present embodiment describes an example in which the projecting portions 52 are provided at the front panel 24, the present disclosure is not limited to this. It suffices for the projecting portions 52 to be provided at regions that are at the rear sides of the seat transverse direction outer sides of a spanning member that spans between the pair of left and right side frames 22 in the left-right direction.

Although an embodiment of the present disclosure has been described above, the present disclosure is not limited to the above and can, of course, be implemented by being modified in various ways other than the above within a scope that does not depart from the gist thereof.

What is claimed is:

1. A vehicle seat, comprising:
a pair of left and right side frames that structure portions of a frame of a seat cushion that supports, from a seat lower side, buttocks and femoral regions of a seated vehicle occupant, and that are disposed with an interval therebetween in a seat left-right direction; and
a spanning member spanning in the seat left-right direction between the pair of left and right side frames, and supporting the femoral regions of the seated vehicle occupant from a lower side,
wherein regions, which are at rear sides of seat transverse direction outer sides, of the spanning member are projecting portions that project toward a seat upper side with respect to the side frames.

2. The vehicle seat of claim 1, wherein:
owing to regions, which are at a seat rear side, of the spanning member being supported portions that are supported at the pair of left and right side frames so as to be rotatable with the seat left-right direction being an axial direction, the spanning member is displaced with respect to the pair of left and right side frames, and a position of a front end portion of the seat cushion in a seat vertical direction is adjusted,
the vehicle seat further comprises a movable portion that is supported by the spanning member and by which a length of the seat cushion in a seat front-rear direction is adjusted owing to the movable portion being displaced in a seat front-rear direction with respect to the spanning member, and
regions of the spanning member, which regions are at a seat upper side with respect to the supported portions, are the projecting portions.

3. The vehicle seat of claim 2, wherein, in a seat side view:
end portions, which are at a seat rear side and a seat upper side, of the projecting portions are first load input portions,
an end portion, which is at a seat front side and a seat upper side, of the movable portion is a second load input portion, and
in a case in which a line that passes through the first load input portion and extends in a direction in which the movable portion is displaced with respect to the spanning member is a contact line,
the second load input portion is positioned further toward a seat lower side than the contact line.

4. The vehicle seat of claim 1, wherein:
in a seat side view of a state in which an AM50 dummy serving as the seated vehicle occupant is seated on the seat cushion,
a line connecting a hip point and a knee joint center of the dummy is a first line,
a line that is parallel to the first line and passes through a projection direction distal end of the projecting portion is a second line, and
a region of the spanning member, which region is further toward a front side than the projecting portions, is positioned further toward a lower side than the second line.

5. The vehicle seat of claim 4, wherein:
in a seat side view of the state in which the dummy is seated on the seat cushion,
a shape and dimensions of the spanning member are configured such that, in a case in which the first line is rotated toward the spanning member side around the hip point, the first line contacts the projecting portions first.

6. The vehicle seat of claim 4, wherein:
in a seat side view of the state in which the dummy is seated on the seat cushion,
the projecting portions are positioned further toward a rear side than a center, on the first line, between the hip point and the knee joint center.

7. The vehicle seat of claim 1, wherein, in a state in which an AM50 dummy serving as the seated vehicle occupant is seated on the seat cushion, the projecting portions are positioned at seat transverse direction outer sides with respect to the dummy.

8. The vehicle seat of claim 2, wherein projecting direction distal ends of the projecting portions are positioned at a rear side with respect to a center of rotation of the supported portions.
